(19) United States
(12) Patent Application Publication
(10) Pub. No.: US 2005/0038700 A1
(43) Pub. Date: Feb. 17, 2005

(54) System and method for creating modular advertisements

(76) Inventors: Marcus Frank Doemling, Lake Hiawatha, NJ (US); Peter J. Matsuo, Albany, NY (US)

Correspondence Address: Peter Matsuo;c/o Fysix Corporation, Suite 4404, 1223 Peoples Avenue, Troy, NY, 12180, US

(21) Appl. No.: 10/915,910

(22) Filed: Aug. 11, 2004

Related U.S. Application Data
(60) Provisional application No. 60/494,117, filed on Aug. 12, 2003.

(51) Int. Cl. G06F 17/60

(52) U.S. Cl. 705/14; 705/26; 705/27

(57) ABSTRACT

A system and method for the development of online advertisements that are built up of a plurality of components and computer file format types, whose interactions, positioning, and other characteristics are flexibly defined and/or modified through a user interface.

### REFERENCE TO PRIOR APPLICATION

The current application claims priority to co-pending provisional application Ser. No. 60/494,117 filed on Aug. 12, 2003.

### BACKGROUND OF THE INVENTION

The proliferation of the Internet and world wide web (hereinafter “web”) has created a great demand for effective content. After all, content is the key element that drives people to a website. Content comes in many forms, including text, graphics, audio, video, multimedia, etc. Numerous applications exist where content is being served over the web to clients.

In the web environment, content is typically embedded “indirectly” in web pages downloaded from a host server to a client (hereinafter “browser”). In particular, the web page will generally include references to content using uniform resource locators (URL) that tell the browser where to retrieve the content. The browser, upon analyzing the web page, will send a request out to the identified location, and the content will be returned and inserted in the web page at a predetermined location.

The use of content made up of a plurality of components, particularly content designed for the purpose of online advertising, has become popular as advertisers struggle to raise their messages above the clutter of content found of the world wide web. There are resource advantages to the modular design of content, in that only those components needed are required to be retrieved. By only retrieving such components, the waste of bandwidth associated with the delivery of content that is not required is reduced. This can also improve the end-user's experience with the content that is required, by reducing delays associated with high bandwidth downloads.

While a number of modular content systems exist, each with a number of market justifications, these systems provide for the assembly of components into a deployable multi-component online advertisements in one of two ways: (i) By manually programming the individual components, their characteristics and their interactions, or (ii) By using computerized authoring environments that facilitate the restricted assembly of components into pre-defined templates. Method (i), pertaining to the manual programming of individual components, typically requires a great deal of time and expertise, often making the process cost-prohibitive for advertising applications. Furthermore, this method requires additional ‘quality-assurance’ checks, which many end-publishers of the content may be reluctant to engage in. Method (ii), pertaining to template-based authoring environments, restricts the flexibility the content-creator has in realizing a creative vision. This method also restricts the precision with which modifications may be effected. It would be desirable to combine the flexibility and comprehensiveness of Method (i) with the speed and simplicity of Method (ii) into a single method characterized by both attributes.

### SUMMARY OF THE INVENTION

The present invention generally relates to the creation of computerized content that consists of a plurality of components, each selected from a group of data formats or collection of formats that are typically used on the world wide web. In particular, content used as online advertising is of interest.

The ability to assemble multiple components into a single online advertisement with granular control over the characteristics of each component and its attributes (such as position, timing, mode of appearance, file-type, etc.) is advantageous in that it provides for greater flexibility in the overall design of the finished product, supports modifications on a component-by-component basis, and allows for the transfer of the components over the world wide web of only those components specifically required for a particular circumstance.

The current invention overcomes the limitations of existing modular content systems by providing tools that facilitate the creation and management of content on a component-by-component basis. Furthermore, this invention provides a method for creating the packaging, i.e. computer code, that facilitates the application of the concept in the context of online advertising. These methods take the form of a software tool that is used to define the components, as well as their properties and interactions.

The present invention provides an efficient system and method for assembling components that combines the flexibility of method (i) as described in the background of this invention, with the ease of use of method (ii), also as described in the background of this invention. Furthermore, due to the flexibility of how the content is assembled and defined, this same system and method also allows for the modification, deletion, addition, and/or swapping of components.

The present invention addresses existing limitations in current solutions by providing a flexible and easy to use computer-based authoring and editing solution, general enough in its design and user interface that the content creator has a broad freedom to realizing any creative vision for the production of online advertisements. The output of the present invention is, in part, a segment of computer code that contains the functionality to deploy the finished content, complete with (i) instructions for the interactions between components and component characteristics and (ii) a broad selection of tracking triggers that will allow for a detailed analysis of end-user interactions with the content, in a form compliant with industry standards. Recognizing that in many circumstances, a rigorously template-based environment may be sufficient, the present invention offers the ability to store predefined templates. The nature of the templates so defined benefit from flexibility of this invention, as they are defined in the same manner that the content is authored, and as such are easily modified as the general acceptability or expectation of market-driven template definitions evolve.

The present invention comprises (a) a computer interface with which the author of the content defines or edits the components, the interaction between the components, and other general characteristics of the components such as when, where, and under what circumstances the components will be displayed, (b) systems that modify or add to the components, as they are manipulated in the aforementioned computer interface, without explicit direction for the author via that interface, and (c) the computer code that stores the output resulting from the use of the user-interface, and that when deployed as a member of relevant computer programs, such as those defining a web page on the internet, will result in the creative vision of the author being realized.

### BRIEF DESCRIPTION OF THE DRAWINGS

The preferred exemplary embodiment of the present invention will hereinafter be described in conjunction with the appended drawings, where like designations denote like elements, and;

FIG. 1 depicts an overall block diagram of the system according to a preferred embodiment of the present invention.

FIG. 2 depicts a more detailed block diagram of the authoring module.

### DETAILED DESCRIPTION OF THE PREFERRED EMBODYMENT

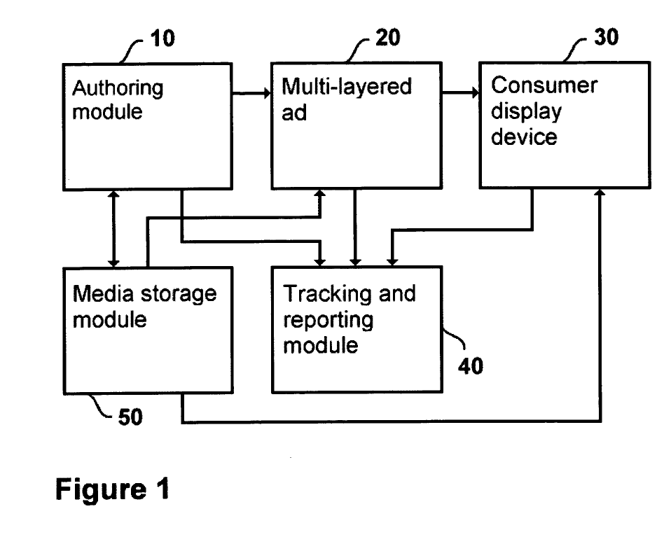

A preferred embodiment of the overview of the system is depicted in FIG. 1. As shown in FIG. 1 the system includes 5 main components: the authoring module 10, the multi layer ad 20, the consumer display device 30, the tracking and reporting module 40 and the media storage module 50. The system provides the means for an ad author to use the authoring module 10 for assembling ad components into a multi-layered ad 20 that can be displayed by a consumer display device 30. The multi-layered ad will contain the necessary computer programming code to interact with the tracking and reporting module 40 for the purpose of accumulating statistical data about the deployed ad. The ad components of the multi-layered ad are stored by the media storage module 50, which makes those components available to the consumer display device.

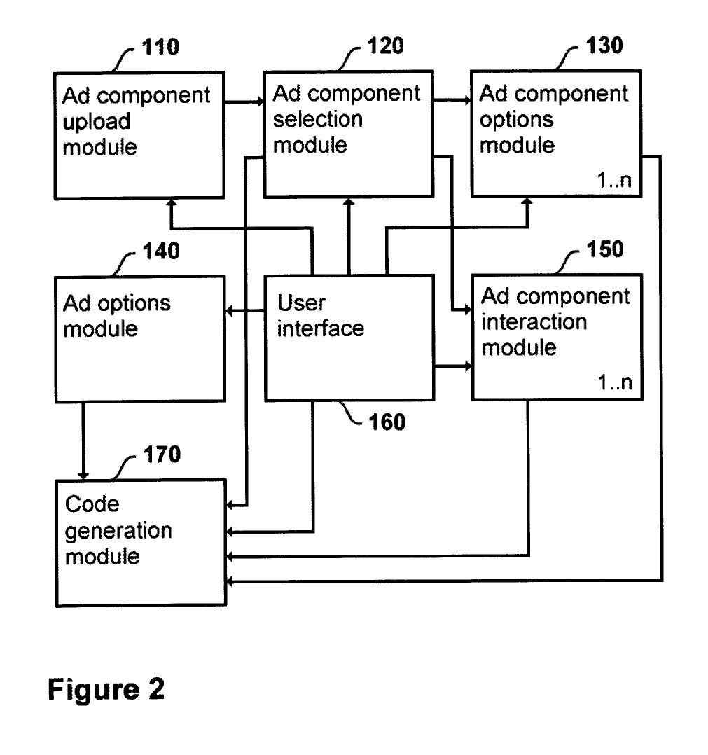

The multi-layered ad 20 is created by the authoring module by assembling one or more ad components and defining the properties, interactions and behaviors of the ad components. FIG. 2 depicts a more detailed diagram of the authoring module 10. Some sub-components of the authoring module 10 can have multiple instances, with one instance for each ad component. The number of ad components is not fixed and can range from a single ad component to many ad components. As the number of ad components changes through addition or removal of ad components the number of instances of some sub-components will adjust accordingly. Such a sub-component with one instance per ad component will be called an n-fold sub-component, with n being the number of ad components. The sub-components of the authoring module 10 include: the ad component upload module 110, the ad component selection module 120, the n-fold ad component options module 130, the ad options module 140, the n-fold ad component interaction module 150, the user interface 160 and the code generation module 170. The authoring module 10 and the ad component upload module 110 also interact with the media storage module 50. The ad component selection module 120, ad component upload module 110, the n-fold ad component options module 130, the ad options module 140 and the n-fold ad component interaction module 150 all are accessed by the ad author through the user interface 160. The ad author can select the ad components that are to be assembled into a multi-layered ad with the ad component selection module 120. New ad components can be added to the authoring module by submitting them through the ad component upload module 110. An ad component is one of various computerized data formats that have various visual, audible or executable representations, including: (i) animated graphics in the form of Compuserve animated GIF files or Macromedia Flash .swf files, (ii) static graphical images in the form of Compuserve GIF files, JPG files or PNG files (iii) sounds, such as in the form of .wav or .mp3 files, (iv) web pages consisting of a variety of text and graphical elements in the form of HTML files, (v) scripts or programming code that act on various elements of a computer, (vi) surveys that present viewers with the ability to enter data in response to questions, (vii) videos, such as in the form of .avi, .asf, .mpeg, .mov or .swf files and (viii) vector based 3D graphics. When submitting new ad components, the ad component upload module 110 will, depending on the type of the ad component, modify the submitted ad component in order to (i) add functionality that can be configured through the ad component options module 130, (ii) enable the authoring module to interact with the ad component, (iii) enable the ad component to interact with other ad components and (iv) enable the ad component to interact with the tracking and reporting module 40. The resulting modified ad component is then stored by the media storage module 50. The original input ad component may also be stored by the media storage module.

The n-fold ad component options module 130 defines parameters for each ad component that affects its properties and behaviors as part of the multi-layered ad. These options include: (i) mechanisms of triggering the ad component, (ii) mechanisms of aborting the ad component, (iii) visual alignment of the ad component, (iv) duration of the display or audible period of the ad component, (v) resizing of the ad component, (vi) the volume of an audible component, (vii) mechanisms of how the ad component transitions from not being displayed into being displayed and vice versa, (viii) visual stacking order of the ad component, (ix) tracking and reporting options, (x) ad component actions in response to consumer display device properties or events, (xi) ad component behavior as function of statistical user data for the consumer, (xii) special effects applied to the ad component, and (xiii) ad component type specific options. The mechanisms for triggering and aborting an ad component include: (a) the elapsing of a defined amount of time from the start of a specific event, (b) the consumer clicking or pointing the mouse cursor or other pointing device at a defined location within the consumer display device or within another ad component, (c) the triggering of a particular ad component and (d) the end of the display period or audible period of a particular ad component. The ad component options module 130 includes options that allow the ad author to create a relationship between an ad component and any other ad component, as described for the mechanisms for triggering and aborting an ad component. These options are n-fold within the ad component options module 130, which is itself n-fold, resulting in n-by-n-fold options that can be represented by square n-by-n matrices. As an example of this consider a multi-layered ad with 5 ad components, each triggered by the end of one of the other ad components. A general solution for defining the triggering relationship between the ad components can be implemented by using a 5-by-5 matrix that defines for each ad component what other ad component triggers it.

The ad component interaction module 150 defines the mechanisms by which a consumer can interact with an ad component and the effects of such interaction. The mechanisms for interaction include: (i) moving the mouse cursor or other pointing device over a defined region of the ad component, (ii) clicking with the mouse or other pointing device on a defined region of the ad component, (iii) double-clicking with the mouse or other pointing device on a defined region of the ad component, (iv) removing the mouse cursor or other pointing device from a region of the ad component, (v) pressing or releasing a particular key or key sequence on the keyboard, (vi) receiving specific input from other input devices (vii) using other events that may be generated in conjunction with an ad component of specific type. The affects of an interaction defined through the ad component interaction module 150 include: (i) the aborting of the ad component, (ii) the outputting of the ad component on a specific output device, such as a printer, (iii) the outputting of another ad component on a specific output device, (iv) the triggering of another ad component, (v) the aborting of another ad component, (vi) the resetting of the internal state of the multi-layered ad, (vii) the loading of another web page, (viii) the interaction with another ad component, including: (a) the playing of a video ad component, (b) the pausing of a video ad component, (c) the stopping of a video ad component, (d) the rewinding of a video ad component, (e) the forwarding of a video ad component, (f) the volume change of an audible ad component, (g) the muting of an audible ad component, (h) other interaction with the ad component that is type specific to the ad component, (i) other interaction with another ad component that is type specific to that ad component.

The ad options module 140 is used to define all options that are not specific to any ad component and affect the multi-layered ad as a whole. These options include: (i) defining a single layer alternative ad for consumer display devices that are not compatible with used ad components or technologies, (ii) defining those consumer display device properties, such as network connection speed, that should cause the alternative ad to be displayed. (iii) defining properties for the statistical consumer user data that should be prerequisites for triggering certain ad components (iv) defining settings that affect the internal workings of the code generation module 170.

The code generation module 170 is responsible for converting the settings for the multi-layered ad and its ad components into a data format, the “code”, that can be loaded into a consumer display device and will cause the multi-layered ad to be displayed according to the specifications entered into the authoring module. After the ad author finishes the selection of ad components and the setting of options the code generation module 170 is invoked and processes the settings and ad components to create the code. The code is then stored by the media storage module 50, where it is made available for download by consumer display devices.

The invention also provides the ability to customize ad components such that they can include extra tracking or other functionality. For example, as a certain file type is uploaded into the invention (e.g. through the Ad Component Upload Module 110), it can be decompiled, code for additional functionality or compatibility can be added, and then recompiled as it is. For example, a video file can be modified in this way to take up less bandwidth than the original file, or to be compatible with various video players.

1. A computer assisted method for creating multi-layer ads comprising the steps of:
selecting one or more ad components from a computerized storage medium;
defining one or more component attributes that specify how the said one or more ad components will be presented by a consumer display device;
defining one or more ad attributes that specify how the multi-layer ad as a whole will be presented by a consumer display device; and
creating computerized code that contains instructions for a consumer display device to present the said one or more ad components under the specifications of the said one or more component attributes and the said one or more ad attributes.

2. The computer assisted method for creating multi-layer ads of claim 1, wherein:
the step of selecting one or more ad components selects said ad components from a group consisting of standard web file formats.

3. The computer assisted method for creating multi-layer ads of claim 2, wherein;
the step of defining one or more component attributes specifies where on a users computer screen the computerized code will instruct the consumer display device to present one or more ad components; and
the step of defining one or more component attributes specifies when the computerized code will instruct the consumer display device to present one or more ad components.

4. The computer assisted method for creating multi-layer ads of claim 3, further comprising:
selecting of one or more events, to give reference to when the computerized code will instruct the consumer display device to present one or more ad components, from the group consisting of:
the triggering of a component;
the aborting of a component;
the user pointing the mouse cursor at a defined location;
the expiration of a defined time interval;
the user clicking a link; and
the user seeing a component for the n-th time, where n is a given integer parameter.

5. The computer assisted method for creating multi-layer ads of claim 1, wherein:
the step of the selecting one or more ad components selects from a group consisting of:
static graphical images;
animated graphics;
web pages;
surveys;
sounds;
videos;
new browser windows;
scripts; and
vector graphics.

6. The computer assisted method for creating multi-layer ads of claim 5, wherein:
the step of defining one or more component attributes to specify where on a users computer screen the computerized code will instruct the consumer display device to present one or more ad components selected from the group consisting of:
positioning the component relative to another component;
positioning the component relative to a user's browser window;
positioning the component relative to the viewable area of a user's screen; and
positioning the component relative the web page in which the content is displayed.

7. The computer assisted method for creating multi-layer ads of claim 3, further comprising:
facilitating the step of defining one or more component attributes by displaying a preview of the display resulting from the instruction of the consumer display device by the computerized code that contains instructions for a consumer display device to present the said one or more ad components under the specifications of the said one or more component attributes.

8. The computer assisted method for creating multi-layer ads of claim 3, wherein;
the step of defining one or more component attributes in order to specify when the computerized code will instruct the consumer display device to present one or more ad components includes selecting one or more events from a plurality of events to give reference to when the computerized code will instruct the consumer display device to present one or more ad components.

9. The computer assisted method for creating multi-layer ads of claim 8, wherein;
the step of selecting one or more events to give reference to when the computerized code will instruct the consumer display device to present one or more ad components specifies the presentation of another of the one or more ad components as said event.

10. The computer assisted method for creating multi-layer ads of claim 8, wherein;
the step of selecting one or more events to give reference to when the computerized code will instruct the consumer display device to present one or more ad components selects the aborting of the presentation of another of the one or more ad components as said event.

11. The computer assisted method for creating multi-layer ads of claim 8, wherein;
the step of selecting one or more events to give reference to when the computerized code will instruct the consumer display device to present one or more ad components selects the user pointing a computerized pointing device at a defined location as said event.

12. The computer assisted method for creating multi-layer ads of claim 8, wherein:
the step of selecting one or more events to give reference to when the computerized code will instruct the consumer display device to present one or more ad components selects the expiration of a defined time interval as said event.

13. The computer assisted method for creating multi-layer ads of claim 8, wherein:
the step of selecting one or more events to give reference to when the computerized code will instruct the consumer display device to present one or more ad components selects the user clicking a link as said event.

14. The computer assisted method for creating multi-layer ads of claim 8, wherein:
the step of selecting one or more events to give reference to when the computerized code will instruct the consumer display device to present one or more ad components selects the presentation of any of the one or more ad components for the n-th time, where n is a given integer parameter, as said event.

15. The computer assisted method for creating multi-layer ads of claim 8, further comprising:
uploading ad components; and
storing the said uploaded ad components in a computerized storage medium.

16. The computer assisted method for creating multi-layer ads of claim 8, further comprising:
the recording and storage of said component attributes and ad attributes in a computerized storage medium such that said component attributes and ad attributes can be loaded to serve as default settings.

17. The computer assisted method for creating multi-layer ads of claim 8, further comprising:
creating the computerized code in such a way that a user's interactions with the ad components are tracked for the purpose of later displaying said interactions data for analysis.

18. A computer assisted method for creating multi-layer ads comprising the steps of:
uploading one or more ad components;
selecting one or more ad components;
defining component attributes that specify how and when the said selected one or more input components will be presented in a computerized platform;
defining ad attributes of the multi-layer ad as a whole; and
generating a computerized representation of the multi-layer ad that is comprised of the selected one or more ad components with said component attributes and said ad attributes.

19. A system of creating multi-layer ads comprising:
an authoring module enabling the assembly of multiple ad components made up of varying computer file format types; and
a media storage module for storing the ad components as computer files.

20. The system of creating multi-layer ads of claim 19, wherein the authoring module comprises:
an ad component upload module;
an ad component options module for specifying one or more component attributes that specify how the said one or more ad components will be presented by a consumer display device;
an ad options module for specifying one or more ad attributes that specify how the multi-layer ad as a whole will be presented by a consumer display device;
an ad component selection module to aid in specifying which ad components the ad component options module and the ad options module are referencing;
a code generation module for creating computerized code that contains instructions for a consumer display device to present the said one or more ad components under the specifications of said one or more component attributes and said one or more ad attributes; and
a media storage module for storing the component attributes and ad attributes.

21. The system of claim 20 wherein the ad component upload module automatically modifies ad components to enable user interactions with the ad component to be tracked.

22. The system of claim 20 wherein the ad component options module includes:
A plurality of predefined options used to specify one or more component attributes to specify where on a users computer screen the computerized code will instruct the consumer display device to present the ad components; and
A plurality of predefined options used to specify one or more component attributes to specify when the computerized code will instruct the consumer display device to present one or more ad components.

23. The system of claim 22 wherein the plurality of predefined options used to specify one or more component attributes to specifies where on a users computer screen the computerized code will instruct the consumer display device to present the one or more ad components are selected from the group consisting of:
the option to position the component relative to another component;
the option to position the component relative to a user's browser window;
the option to position the component relative to the viewable area of a user's screen; and
the option to position the component relative the web page in which the content is displayed.

24. The system of claim 22 wherein the plurality of predefined options used to specify one or more component attributes to specify when the computerized code will instruct the consumer display device to present one or more ad components are selected from the group consisting of:
the triggering of a component;
the aborting of a component;
the user pointing the mouse cursor at a defined location;
the expiration of a defined time interval;
the user clicking a link; and
the user seeing a component for the n-th time, where n is a given integer parameter.

25. The system of claim 22 wherein the authoring module further comprises:
a system to present a preview of the multi-layer ad in the context of any web page under the specifications of the said one or more component attributes.

26. The system of claim 22 where in the code generation module automatically modifies the multi-layer ad to enable interactions with the multi-layer ad to be tracked.

27. The system of claim 20 wherein the authoring module further comprises an ad component interaction module for specifying interaction attributes that specify the result of a user's interactions with the one or more ad components.

28. The system of claim 27 wherein the user interactions are selected from the group consisting of:
moving the mouse cursor or other pointing device over a defined region of the ad component;
clicking with the mouse or other pointing device on a defined region of the ad component;
double-clicking with the mouse or other pointing device on a defined region of the ad component;
removing the mouse cursor or other pointing device from a region of the ad component; and
pressing or releasing a particular key sequence on the keyboard.

29. The system of claim 27 wherein the results of the user's interactions are selected from the group consisting of:
the aborting of the ad component;
the outputting of the ad component on a specific output device;
the outputting of another ad component on a specific output device;
the triggering of another ad component; and
the aborting of another ad component.

30. A system for creating multi-layer ads comprising:
an ad component upload module;
an ad component selection module for selecting which ad components are to be used for the multi-layer ad;
an ad component options module for specifying a plurality of attributes of each ad component;
an ad options module for specifying a plurality of attributes of the multi-layer ad as a whole;
an ad component interaction module for defining how a viewer of the multi-layer ad can interact with the ad component;
a code generation module for creating a computerized representation of the multi-layer ad based on the selected ad components, their respective component attributes, the ad attributes for the multi-layer ad as a whole and the definitions for the ad component interactions; and
a media storage module for storing ad components, ad component attributes, multi-layer ad options, and ad component interactions.
